(19) United States
(12) Patent Application Publication
(10) Pub. No.: US 2021/0400981 A1
(43) Pub. Date: Dec. 30, 2021

(54) ANTIMICROBIAL OZONE COMPOSITIONS AND METHODS OF USE THEREOF

(71) Applicants: CleanCore Solutoins, Omaha, NE (US); BOARD OF REGENTS OF THE UNIVERSITY OF NEBRASKA, Lincoln, NE (US)

(72) Inventors: James E. Talmadge, Bellevue, NE (US); Michael Draper, Omaha, NE (US); Holly Britton, Omaha, NE (US); Andrew M. Worlie, Elkhorn, NE (US); Evan D. Marlow, Omaha, NE (US)

(73) Assignee: BOARD OF REGENTS OF THE UNIVERSITY OF NEBRASKA, Lincoln, NE (US)

(21) Appl. No.: 16/620,009

(22) PCT Filed: Jul. 24, 2019
(86) PCT No.: PCT/US19/43208

§ 371 Date: Dec. 6, 2019

Related U.S. Application Data
(60) Provisional application No. 62/703,093, filed on Jul. 25, 2018.
(60) Provisional application No. 62/731,320, filed on Sep. 14, 2018.

(51) Int. Cl. A01N 59/00; A01N 25/22; A01N 25/02; A23B 7/157

(52) U.S. Cl. CPC A01N 59/00; A23B 7/157; A01N 25/02; A01N 25/22

(57) ABSTRACT

Antimicrobial aqueous ozone compositions and methods of use thereof are provided.

This application claims priority under 35 U.S.C. § 119(e) to U.S. Provisional Patent Application No. 62/703,093, filed on Jul. 25, 2018, and U.S. Provisional Patent Application No. 62/731,320, filed on Sep. 14, 2018. The foregoing applications are incorporated by reference herein.

### FIELD OF THE INVENTION

The present invention relates to the field of antimicrobial aqueous ozone compositions. More specifically the invention provides aqueous ozone compositions with improved antimicrobial activity and methods of use thereof.

### BACKGROUND OF THE INVENTION

The antimicrobial properties of ozone are well documented and it has been used in the municipal water treatment industry for decades. Ozone is also recognized and validated as a hard surface sanitizer and anti-microbial food rinse in the food processing industry. Ozonated water or aqueous ozone is as an effective cleaner and anti-microbial agent that may be utilized in a variety of cleaning environments and applications. It can be used on a variety of hard surfaces from floors and drains to walls, tanks, as wells as soft surfaces such as carpet and fabrics; and on living surfaces such as food products like fruits, vegetables and meat products. Aqueous ozone can also reduce microbial contamination on surfaces and surgical tools under specific conditions (Cesar, et al., J. Infect. Public Health (2012) 5(4):269-274; Bialoszewski, et al., Med. Sci. Monit. (2011) 17(11):BR339-344). Safely improving the antimicrobial activity of aqueous ozone is desired to more effectively utilize it as a sanitizer or disinfectant.

### SUMMARY OF THE INVENTION

In accordance with one aspect of the instant invention, aqueous ozone compositions are provided. In a particular embodiment, the aqueous ozone composition comprises or consists of water, ozone, and a buffering agent. In a particular embodiment, the buffering agent has the formula R—COOH—wherein R is an alkyl, particularly a lower alkyl—or a salt thereof. In a particular embodiment, the aqueous ozone composition comprises or consists of water, ozone, and peracetic acid (PAA, also known as peroxyacetic acid). In a particular embodiment, the aqueous ozone composition comprises water, ozone, the buffering agent and PAA.

In accordance with another aspect of the instant invention, methods for cleaning, disinfecting, sanitizing, decontaminating, and/or sterilizing are provided. The methods comprise applying an aqueous ozone composition of the instant invention to the surface (e.g., biological or non-biological) to be treated. In a particular embodiment, the method reduces the number of living organisms (e.g., bacteria) by at least 99.9% or 99.99% (e.g., in aggregate/mean).

### DETAILED DESCRIPTION OF THE INVENTION

Herein, aqueous ozone compositions having increased antimicrobial activity are provided. In a particular embodiment, the aqueous ozone compositions of the instant invention are buffered to have a reduced pH. For example, the aqueous ozone compositions of the instant invention may have a pH from about 5.25 to about 6.25, particularly about 5.5 to about 6.0. In a particular embodiment, the aqueous ozone composition of the instant invention is buffered with a compound of the formula R—COOH—wherein R is an alkyl, particularly a lower alkyl—or a salt thereof (e.g., a sodium salt or a potassium salt). In a particular embodiment, the buffering agent is a short chain fatty acid (e.g., a fatty acid with a chain length up to 6 carbon atoms). Examples of buffering agents of the instant invention include, without limitation: butyric acid, propionic acid, acetic acid, formic acid, isobutyric acid, valeric acid, isovaleric acid, and salts thereof. In a particular embodiment, the buffering agent is selected from the group consisting of propionic acid, butyric acid, acetic acid, and salts thereof. In a particular embodiment, the buffering agent is acetic acid and salts thereof.

In a particular embodiment, the aqueous ozone composition of the instant invention comprises or consists of water, ozone, and peracetic acid. In a particular embodiment, the ozone concentration of the composition is in a range of about 0.1 ppm to about 200 ppm, about 1 ppm to about 100 ppm, about 0.1 ppm to about 20 ppm, or about 10 ppm to about 20 ppm. In a particular embodiment, the PAA concentration of the composition is in a range of about 10 ppm to about 1000 ppm.

Ozone is an unstable molecule with a relatively short half-life. In aqueous solutions, ozone can decompose over the course of a few hours. Accordingly, it is preferable that the aqueous ozone composition is made fresh prior to application. The aqueous ozone compositions of the present invention may be prepared in a variety of ways, according to known methods. Indeed, there are multiple methods for producing aqueous solutions of ozone. For example, aqueous ozone may be generated by a corona discharge technique, irradiating an oxygen-containing gas with ultraviolet light, or using an electrolytic reaction. In a particular embodiment, the aqueous ozone is generated using the methods and systems described in U.S. Pat. Nos. 8,075,705; 8,071,526; 9,174,845; and 9,522,348, incorporated by reference herein.

The aqueous ozone compositions of the instant invention comprise water. The water may be untreated (e.g., tap water) or treated (e.g., distilled, filtered, and/or purified (e.g., by reverse osmosis)) or optimally treated. In a particular embodiment, the water of the composition is tap water. In a particular embodiment, the water is soft water, either naturally or through a water softening process to remove certain cations (e.g., calcium and/or magnesium) and other materials that cause hard water. In a particular embodiment, the water is at a temperature between about 33° F. and 80° F., particularly between 35° F. and 50° F., between 36° F. and 40° F., or about 38° F. In a particular embodiment, the water is at room temperature. In a particular embodiment, the aqueous ozone compositions of the instant invention comprise water, ozone, and a buffering agent and/or PAA. In a particular embodiment, the aqueous ozone compositions of the instant invention consist of water, ozone, and a buffering agent (e.g., a short chain fatty acid) and/or PAA.

The aqueous ozone compositions of the instant invention may be saturated with ozone or may have sub-saturation levels of ozone. In a particular embodiment, the aqueous ozone composition has a concentration of ozone of up to 100 ppm, up to 50 ppm, or, particularly up to 20 ppm. In a particular embodiment, the ozone concentration of the aqueous ozone composition is from about 0.1 ppm to about 20 ppm, particularly about 0.1 ppm to about 10 ppm, about 0.5 ppm to about 5 ppm, about 1.0 ppm to about 5 ppm, about 0.5 to about 3.0 ppm, about 1.0 ppm to about 3.0 ppm, or about 1.5 ppm.

As explained hereinabove, the buffering agent may be a compound of the formula R—COOH—wherein R is an alkyl, particularly a lower alkyl—or a salt thereof (e.g., a sodium salt). Examples of buffering agents of the instant invention include, without limitation: butyric acid, propionic acid, and acetic acid, and salts thereof, particularly propionic acid or acetic acid. The buffering agent may be present at a concentration to maintain the pH of the aqueous ozone composition from about 3 to about 8, about 5 to about 7, about 5.25 to about 6.25, particularly about 5.5 to about 6.0. In a particular embodiment, the concentration of the buffering agent is about 0.01 M to about 5.0 M, about 0.01 M to about 1.0 M, particularly about 0.02 to about 0.8 M, about 0.03 M to about 0.5 M, about 0.05 to about 0.1 M, or about 0.05 M.

With regard to aqueous ozone compositions comprising PAA, the PAA may be present at antimicrobial levels. In a particular embodiment, the aqueous ozone composition has a concentration of PAA of up to 1000 ppm. In a particular embodiment, the PAA concentration of the aqueous ozone composition is from about 1 ppm to about 1000 ppm, particularly about 5 ppm to about 500 ppm, about 10 ppm to about 1000 ppm, about 10 ppm to about 500 ppm, about 20 ppm to about 500 ppm, about 10 to about 100 ppm, or about 20 ppm to about 100 ppm.

In accordance with another aspect of the instant invention, methods of cleaning, disinfecting, sanitizing, decontaminating, and/or sterilizing a surface are provided. The method comprises applying the aqueous ozone composition of the instant invention to the surface to be treated. In a particular embodiment, the aqueous ozone composition is applied for less than 30 minutes, less than 15 minutes, less than 10 minutes, or less than 5 minutes to the surface being treated. In a particular embodiment, the methods of the instant invention result in at least a 99.9% reduction, particularly at least a 99.99% reduction, in living microorganisms on the surface, particularly bacteria.

Aqueous ozone is effective against a wide variety of microorganisms (Nagayoshi et al., Oral Microbiol. Immunol. (2004) 19:240-246; Cesar, et al., J. Infect. Public Health (2012) 5:269-274; deCandia, et al., Front. Microbiol. (2015) 6:733; Bachelli, et al., Braz. J. Microbiol. (2013) 44:673-678; Greene et al., J. Dairy Sci. (1993) 76:3617-3620; Fontes, et al., BMC Infect. Dis. (2012) 12:358; Bialoszewski, et al., Med. Sci. Monit. (2011) 17:BR339-344; Antony-Babu, et al., Antoine Van Leeuwenhoek (2009) 96:413-422; Cho et al., Appl. Environ. Microbiol. (2003) 69:2284-2291; Shin et al., Appl. Environ. Microbiol. (2003) 69:3975-8; Katzenelson, et al., J. Am. Water Works Assoc. (1974) 66:725-729; Murray et al., J. Virol. Methods (2008) 153:74-7; Cataldo, F., Int. J. Biol. Macromol. (2006) 38:248-254; Ito, et al., Mutat. Res. (2005) 585:60-70). As explained herein, the aqueous ozone compositions of the instant invention are effective against microorganisms such as bacteria, fungi, viruses, parasites, or protozoans, particularly bacteria. The bacteria may be a Gram-positive bacteria or a Gram-negative bacteria. In a particular embodiment, the bacteria is a staphylococcal strain, particularly Staphylococcus aureus (including methicillin-resistant Staphylococcus aureus (MRSA)). In a particular embodiment, the microorganism is resistant to aqueous ozone (in the absence of the buffering agent of the instant invention or PAA). In a particular embodiment, the microorganism is an antibiotic-resistant bacteria or an ESKAPE pathogen. In a particular embodiment, the microbe is selected from the group consisting of Enterococcus faecium, Staphylococcus aureus, Klebsiella pneumoniae, Acinetobacter baumanii, Pseudomonas (e.g., Pseudomonas aeruginosa, Pseudomonas fluoroscens), Enterobacter species, Streptococcus (e.g., Streptococcus pneumoniae, Streptococcus mutans), Salmonella (both typhi and non-typhoidal strains), Shigella, Listeria (e.g., Listeria monocytogenes), Campylobacter, Escherichia Coli, Alcalignes faecalis, Bacillus atropheus, and Clostridium (e.g., C. difficile). In a particular embodiment, the microorganism is a fungus such as, without limitation, saccharomyces, Candida (e.g., Candida albicans), Aspergillus (e.g., Aspergillus nidulans, Aspergillus ochraceus), or Stachybotrys. In a particular embodiment, the microorganism is a virus such as, without limitation, norovirus, Norwalk virus, poliovirus, coliphage MS2, herpes simplex virus, vesicular stomatitis virus, vaccinia virus, adenovirus, and influenza.

The surface to be treated by the methods of the instant invention can be any type of surface. For example, the surface may be a biological surface. The surface does not need to be hard, flat, and smooth. For example, the methods can be used on carpets, fabrics, or rough surfaces as well as on soft surfaces and living surfaces. Examples of surfaces to be treated include, without limitation: floors, wood, glass, carpets, counters, sinks, water fixtures or systems, desktops, stainless steel, skin, meat, produce, fruits, vegetables, processed food components, and other natural or processed foods. The surface to be treated may be located, for example, in health care or medical facilities, hospitals, spas, exercise facilities, food processing, packaging, or preparation facilities, and the like. The method of treatment may be an application in the form of a spray (mist, vapor, shower) onto the surface, a rinse of the object having the surface, or a submersion of the object having the surface into the aqueous ozone composition, including a food rinse process. In a particular embodiment, the method comprises dipping, spraying, and/or submersion of a food product (e.g., meat or carcasses (e.g., chicken), skin, produce, fruits, vegetables, processed food components, and other natural or processed foods) with an aqueous ozone composition of the instant invention.

In accordance with another aspect of the instant invention, methods for reducing ambient PAA or PAA gas (e.g., PAA odor) are provided. The method comprises adding ozone (e.g., at the concentrations set forth above) to a solution comprising PAA. The concentrations of PAA and ozone are as set forth above.

### Definitions

The following definitions are provided to facilitate an understanding of the present invention.

The singular forms “a,” “an,” and “the” include plural referents unless the context clearly dictates otherwise.

The term “antimicrobials” as used herein indicates a substance that kills or inhibits the growth of microorganisms such as bacteria, fungi, viruses, or protozoans, particularly bacteria.

The term “sterilization” generally refers to the inactivation/death or elimination or removal of all microorganisms (e.g., fungi, bacteria, viruses, protozoa, etc.) on a surface or object. While sterilization includes a total absence of living microorganisms, the term also encompasses the removal of living microorganisms to an industry accepted standard for sterilization.

The terms “sanitizing” and “disinfecting” generally refers to substantially reducing the number of microorganisms (e.g., fungi, bacteria, viruses, protozoa, etc.) on a surface. For example, the terms may refer to a 1 to 5-log reduction in the number of living microorganisms on a surface. “Sanitizing” and “disinfecting” do not require the complete elimination of microorganisms.

The term “alkyl,” as employed herein, includes saturated or unsaturated, straight or branched chain hydrocarbons containing 1 to about 20 carbons, particularly about 1 to about 10 carbons, in the normal/main chain. An alkyl may, optionally, be substituted (e.g. with 1 to about 4 substituents). The term “lower alkyl” refers to an alkyl which contains 1 to 3 carbons in the hydrocarbon chain (e.g., methyl, ethyl, or propyl).

The following examples describe illustrative methods of practicing the instant invention and are not intended to limit the scope of the invention in any way.

### Example 1

Acetic acid (C₂H₄O₂) is a short chain fatty acid with a pKa (logarithmic acid dissociation constant) of 4.76 that is used in industry as part of film and plastic manufacturing, as well as in the home as a “green” cleaning agent in the form of vinegar which is ˜4% w/v or ˜0.7M acetic acid solution. Acetic acid has been shown to have antimicrobial properties against certain wound-infecting pathogens (Halstead, et al., PLoS One (2015) 10(9):e0136190), to be able to inhibit Escherichia coli O157:H7, Salmonella, and Listeria monocytogenes on certain surfaces (Carpenter, et al., Meat Sci. (2011) 88(2):256-60), and to have activity against Mycobacterium tuberculosis (Cortesia, et al., MBio (2014) 5(2):e00013-14).

Citric acid (C₆H₈O₇) is a weak tricarboxylic acid with three pKa values (3.14, 4.77, and 6.39) that is used in the pharmaceutical industry as an anticoagulant and as an excipient. It occurs naturally in citrus fruits such as lemons and limes. It has been shown to have some antimicrobial activity against Pseudomonas aeruginosa (Yabanoglu, et al., Int. Surg. (2013) 98(4):416-23) and to be able to inhibit Escherichia coli O157:H7 and Salmonella on certain surfaces (Laury, et al., J. Food Prot. (2009) 72(10):2208-11).

Oxalic acid (C₂H₂O₄) which is an odorless, white, solid, dicarboxylic acid with pKa values of 1.46 and 4.40. Oxalic acid is naturally occurring in some plants and vegetables such as spinach and rhubarb. Consumption of oxalic acid/oxalates has been associated with an increased incidence of kidney stones (De, et al., Urology (2014) 84(5):1030-3). Oxalic acid also shows some limited antimicrobial activity in combination with other cleaners.

2-(N-morpholino) ethane sulfonic acid (MES) (C₆H₁₃NO₄S) is a synthetic buffer which is a white, crystalline solid that is water soluble, and as a zwitterionic compound is used in laboratories as a buffer for analytic studies (Good, et al., Biochemistry (1966) 5:467-477). It has a pKa of 6.10.

Ascorbic acid, or vitamin C, (C₆H₈O₆) is a white to pale yellow crystalline solid with two pKa values (4.10 and 11.79). It is found naturally in citrus fruit and some vegetables and is an essential dietary vitamin. In the body, it assists in the formation of collagen and as a reducing agent and antioxidant.

### Materials and Methods

A freeze-dried stock of Staphylococcus (S. aureus subspecies aureus Rosenbach, strain FDA 209) was obtained from American Type Culture Collection (ATCC, Manassas, Va.). After rehydration and growth in appropriate culture medium (Staphylococcus: BD Tryptic soy broth lot #4335611), both plated stocks and stocks frozen in glycerol were created. Staphylococcus was qualified for absorbance at 600 nm versus colony forming units (CFU) by serially diluting inoculum and reading absorbance followed by plating of dilutions onto agar plates. Prior to buffered aqueous ozone testing, growth medium was inoculated and incubated in a shaker incubator (New Brunswick Scientific, serial #890615130) at 37° C. for 24 hours and then transfer cultured two additional times with a final incubation of 48 hours. Twenty microliters of the resulting inoculum were used to coat glass slides (Fisher), also known as test squares or coupons with 10⁵ to 10⁷ cells, as calculated from the standard curve generated from the absorbance qualification data, and allowed to dry in a 37° C. incubator for 40 minutes following ASTM E1153-14 (www.astm.org/Standards/E1153.htm). The experiments tested a single concentration of buffered aqueous ozone (1.5 ppm) with a treatment time of 5 minutes. Briefly, buffered aqueous ozone was generated using the free standing CleanCore™ Technologies 1.0 (CCT 1.0; CleanCore, Omaha, Nebr.) (mounted in a kiosk enclosure) at a concentration of 1.5 ppm. The water source utilized by the CCT 1.0 unit was clean, cold, softened municipal tap water. Acetate buffer made with a combination of acetic acid and its sodium salt, sodium acetate, was added to the water to provide buffering capability and keep the pH slightly acidic at approximately pH 5.5-6. Citrate buffer and oxalate buffer were created with citric acid and oxalic acid respectively, with their corresponding sodium salts, at approximately pH 5.5. Buffered aqueous ozone was collected in a biological safety cabinet before being applied to the appropriate coupons contained within 50 ml conical vials using a pipette. As a control, the same buffer without aqueous ozone was used, although for some qualification experiments water was used as a control. An overview of the parameters is shown in Tables 1A, 1B, and 1C.

TABLE 1A
Experimental conditions, acetate buffered aqueous ozone.

| | Qualification | | | |
|---|---|---|---|---|
| | 1 | 2 | 3 | 4 |
| Water Source | Tap | Tap | Tap | Tap |
| CleanCore | CCT 1.0 | CCT 1.0 | CCT 1.0 | CCT 1.0 |
| System | | | | |
| Organism | S. aureus | S. aureus | S. aureus | S. aureus |
| Coupon | Glass | Glass | Glass | Glass |
| Buffer | 0.05M acetate, | 0.05M acetate, | 0.05M acetate, | 0.05M acetate, |
| | pH 4 | pH 4 | pH 5.5 | pH 6 |
| Approx. | 7,230,000 | 1,130,000 | 867,000 | 2,100,000 |
| bacterial load | | | | |
| by absorbance | | | | |
| PPM | 1.5 | 1.5 | 1.5 | 1.5 |
| Temp. ° C. | Room | Room | Room | Room |
| Incubation | 5 min | 5 min | 5 min | 5 min |
| time | | | | |

TABLE 1B
Experimental conditions, acetate buffered aqueous ozone.

| | Experiment | | |
|---|---|---|---|
| | 1 | 2 | 3 |
| Water Source | Tap | Tap | Tap |
| CleanCore System | CCT 1.0 | CCT 1.0 | CCT 1.0 |
| Organism | S. aureus | S. aureus | S. aureus |
| Coupon | Glass | Glass | Glass |
| Buffer | 0.05M acetate | 0.05M acetate | 0.05M acetate |
| Approx. bacterial | 2,100,000 | 1,740,000 | 2,130,000 |
| load by absorbance | | | |
| PPM | 1.5 | 1.5 | 1.5 |
| Temp. ° C. | Room | Room | Room |
| Incubation time | 5 min | 5 min | 5 min |
| | 4 | 5 | 6 |
| Water Source | Tap | Tap | Tap |
| CleanCore System | CCT 1.0 | CCT 1.0 | CCT 1.0 |
| Organism | S. aureus | S. aureus | S. aureus |
| Coupon | Glass | Glass | Glass |
| Buffer | 0.1M acetate | 0.1M acetate | 0.1M acetate |
| Approx. bacterial | 2,260,000 | 1,550,000 | 1,800,000 |
| load by absorbance | | | |
| PPM | 1.5 | 1.5 | 1.5 |
| Temp. ° C. | Room | Room | Room |
| Incubation time | 5 min | 5 min | 5 min |

TABLE 1C
Experimental conditions, citrate or oxalate buffered aqueous ozone.

| | Experiment | | | |
|---|---|---|---|---|
| | 1 | 2 | 3 | 4 |
| Water Source | Tap | Tap | Tap | Tap |
| CleanCore | CCT 1.0 | CCT 1.0 | CCT 1.0 | CCT 1.0 |
| System | | | | |
| Organism | S. aureus | S. aureus | S. aureus | S. aureus |
| Coupon | Glass | Glass | Glass | Glass |
| Buffer | Citrate | Citrate | Citrate | Citrate |
| Approx. | 1,740,000 | 2,620,000 | 1,190,000 | 2,010,000 |
| bacterial load | | | | |
| by absorbance | | | | |
| PPM | 1.5 | 1.5 | 1.5 | 1.5 |
| Temp. ° C. | Room | Room | Room | Room |
| Incubation time | 5 min | 5 min | 5 min | 5 min |
| | 5 | 6 | 7 | |
| Water Source | Tap | Tap | Tap | |
| CleanCore | CCT 1.0 | CCT 1.0 | CCT 1.0 | |
| System | | | | |
| Organism | S. aureus | S. aureus | S. aureus | |
| Coupon | Glass | Glass | Glass | |
| Buffer | Oxalate | Oxalate | Oxalate | |
| Approx. | 1,330,000 | 3,080,000 | 2,760,000 | |
| bacterial load | | | | |
| by absorbance | | | | |
| PPM | 1.5 | 1.5 | 1.5 | |
| Temp. ° C. | Room | Room | Room | |
| Incubation time | 5 min | 5 min | 5 min | |

After incubation for 5 minutes following ASTM E1153-14, the supernatant in the vial was sampled and placed on test agar plates at a volume of 0.2 ml. An aliquot was also taken for serial dilution at 1:10, 1:100, and/or 1:1000 in tryptic soy broth, which were also placed on test agar plates. All test plates were plated with 0.2 ml spread onto 2 replicates using a glass spreader and an inoculating turntable (Bel-Art, Wayne, N.J.). All plates were then incubated at 37° C. for 48±4 hours. Colony forming units (CFU) for each plate were counted, recorded and averaged for each sample. In order to meet the validity criteria of the method, the control coupons must show at least 7.5×10⁵ surviving organisms. Sample CFUs were analyzed for statistical significance using the Mann Whitney U test with significance level α=0.05.

### Results

A summary of the CFU reductions measured on the coupon surfaces for the buffers and the buffered aqueous ozone is presented in Table 2A.

TABLE 2A
Summary of experimental results.

| | Experiment | | | | |
|---|---|---|---|---|---|
| CleanCore | CCT 1.0 | CCT 1.0 | CCT 1.0 | CCT 1.0 | CCT 1.0 |
| System | | | | | |
| Organism | S. aureus | S. aureus | S. aureus | S. aureus | S. aureus |
| Buffer | 0.01M sodium | 0.05M sodium | 0.1M sodium | citrate | oxalate |
| | acetate | acetate | acetate | | |
| 1.5 ppm buffered | | | | | |
| aqueous ozone | | | | | |
| Geometric mean | 42,587,584 | 27,699,160 | 27,699,160 | 37,093,881 | 33,215,124 |
| bacterial load | | | | | |
| (CFU) | | | | | |
| Geometric mean | 2,307,652 | 1,119,356 | 2,543,358 | 1,565,328 | 2,079,263 |
| control CFU | | | | | |
| count | | | | | |
| Geometric mean | 6,520 | 73 | 121 | 759,143 | 659,847 |
| treated CFU | | | | | |
| count | | | | | |
| Average % | 99.72 | 99.99 | 100.00 | 51.50 | 68.27 |
| reduction vs. | | | | | |
| control by 1.5 | | | | | |
| ppm buffered | | | | | |
| aqueous ozone | | | | | |

While each of the buffered aqueous ozone tests showed improved bacterial inactivation over the buffer solutions alone, shown as the control (rather than an aqueous control), the sodium acetate buffer interacted with the aqueous ozone in a manner superior to the citrate and oxalate buffers. All three concentrations of sodium acetate buffer (0.01, 0.05 and 0.1 M) produced a buffered aqueous ozone solution with a pH 6 and a bacterial percent reduction of 99.72% to 100%. Individual test results for the buffers are presented in Tables 2B, 2C, 2D, and 2E. After exposure to 1.5-ppm acetate buffered ozone for five minutes, there was a statistically significant decrease in Staphylococcus CFU with acetate, citrate, and oxalate buffered aqueous ozone, but only acetate buffered aqueous ozone reached an average percent reduction of 99.9% at concentrations of 0.05M and 0.1M. Neither citrate nor oxalate buffer combined with ozone was able to achieve a greater than 80% reduction in CFU relative to buffer alone.

TABLE 2B
Summary of experimental results, acetate buffered aqueous ozone.

| | Experiment | | |
|---|---|---|---|
| | 1 | 2 | 3 |
| CleanCore System | CCT 1.0 | CCT 1.0 | CCT 1.0 |
| Organism | S. aureus | S. aureus | S. aureus |
| Incubation time | 5 min | 5 min | 5 min |
| Approx. bacterial | 22,000,000 | 23,000,000 | 42,000,000 |
| load (CFU) | | | |
| Buffer alone | 1,533,521 | 988,392 | 925,308 |
| 1.5 ppm in buffer | 78 | 1,088 | 4 |
| % reduction vs. | 99.99 | 99.89 | 100.0 |
| negative control - | | | |
| coupon (1.5 ppm) | | | |
| | 4 | 5 | 6 |
| CleanCore System | CCT 1.0 | CCT 1.0 | CCT 1.0 |
| Organism | S. aureus | S. aureus | S. aureus |
| Incubation time | 5 min | 5 min | 5 min |
| Approx. bacterial | 48,000,000 | 38,500,000 | 11,500,000 |
| load (CFU) | | | |
| Buffer alone | 2,004,173 | 1,632,269 | 5,029,163 |
| 1.5 ppm in buffer | 16 | 1 | 48,329 |
| % reduction vs. | 100.0 | 100.0 | 99.04 |
| negative control - | | | |
| coupon (1.5 ppm) | | | |

Experiments 1-3 tested 0.05M acetate buffer at pH˜6 while experiments 4-6 tested 0.1M acetate buffer at pH˜6.

TABLE 2C
Summary of experimental results, 0.01M
acetate buffered aqueous ozone at pH ~6.

| | Experiment | | |
|---|---|---|---|
| | 1 | 2 | 3 |
| CleanCore System | CCT 1.0 | CCT 1.0 | CCT 1.0 |
| Organism | S. aureus | S. aureus | S. aureus |
| Incubation time | 5 min | 5 min | 5 min |
| Approx. bacterial | 58,500,000 | 39,000,000 | 33,500,000 |
| load (CFU) | | | |
| Buffer alone | 2,222,253 | 1,768,079 | 2,805,775 |
| 1.5 ppm in buffer | 701,081 | 37 | 366 |
| % reduction vs. | 68.45 | 100.00 | 99.99 |
| negative control - | | | |
| coupon (1.5 ppm) | | | |
| | 4 | 5 | 6 |
| CleanCore System | CCT 1.0 | CCT 1.0 | CCT 1.0 |
| Organism | S. aureus | S. aureus | S. aureus |
| Incubation time | 5 min | 5 min | 5 min |
| Approx, bacterial | 48,500,000 | 43,500,000 | 37,000,000 |
| load (CFU) | | | |
| Buffer alone | 2,684,895 | 1,532,903 | 3,328,371 |
| 1.5 ppm in buffer | 1,300,236 | 13 | 443,534 |
| % reduction vs. | 51.57 | 100.0 | 86.67 |
| negative control - | | | |
| coupon (1.5 ppm) | | | |

TABLE 2D
Summary of experimental results, 0.05M citrate
or 0.05M oxalate buffers at pH ~5.5.

| | Experiment | | | |
|---|---|---|---|---|
| | 1 | 2 | 3 | 4 |
| CleanCore System | CCT 1.0 | CCT 1.0 | CCT 1.0 | CCT 1.0 |
| Organism | S. aureus | S. aureus | S. aureus | S. aureus |
| Incubation time | 5 min | 5 min | 5 min | 5 min |
| Buffer | Citrate | Citrate | Citrate | Citrate |
| Approx. bacterial | 39,000,000 | 36,500,000 | 35,000,000 | 38,000,000 |
| load (CFU) | | | | |
| Buffer alone | 3,571,587 | 1,237,371 | 1,410,989 | 962,800 |
| 1.5 ppm in buffer | 873,044 | 826,015 | 820,053 | 579,209 |
| % reduction vs. | 75.56 | 33.24 | 41.88 | 39.84 |
| negative control - | | | | |
| coupon (1.5 ppm) | | | | |
| | 5 | 6 | 7 | |
| CleanCore System | CCT 1.0 | CCT 1.0 | CCT 1.0 | |
| Organism | S. aureus | S. aureus | S. aureus | |
| Incubation time | 5 min | 5 min | 5 min | |
| Buffer | Oxalate | Oxalate | Oxalate | |
| Approx. bacterial | 10,800,000 | 58,500,000 | 58,000,000 | |
| load (CFU) | | | | |
| Buffer alone | 1,893,549 | 2,040,147 | 2,326,967 | |
| 1.5 ppm in buffer | 366,127 | 861,829 | 910,494 | |
| % reduction vs. | 80.66 | 57.76 | 60.87 | |
| negative control - | | | | |
| coupon (1.5 ppm) | | | | |

TABLE 2E
A summary of the CFU reductions measured on the coupon surfaces for the buffer and the buffered aqueous ozone.

| | Experiment | | | | | |
|---|---|---|---|---|---|---|
| CleanCore | CCT 1.0 | CCT 1.0 | CCT 1.0 | CCT 1.0 | CCT 1.0 | CCT 1.0 |
| System | | | | | | |
| Organism | S. aureus | S. aureus | S. aureus | S. aureus | S. aureus | S. aureus |
| Buffer | 0.05M acetate | 0.05M acetate | 0.05M acetate | 0.05M acetate | 0.05M acetate | 0.05M acetate |
| 1.5 ppm buffered | | | | | | |
| aqueous ozone | | | | | | |
| Average | 26,000,000 | 50,500,000 | 78,500,000 | 111,000,000 | 39,500,000 | 27,500,000 |
| bacterial | | | | | | |
| load (CFU) | | | | | | |
| Geometric mean | 1,603,111 | 2,567,895 | 3,443,392 | 6,509,532 | 1,517,413 | 1,116,447 |
| control | | | | | | |
| CFU count | | | | | | |
| Geometric | 1,263,989 | 879,809 | 1,637,603 | 819,717 | 962,389 | 142,539 |
| mean buffer | | | | | | |
| CFU count | | | | | | |
| Geometric mean | 997 | 40 | 87 | 130 | 4 | 6,032 |
| treated | | | | | | |
| CFU count | | | | | | |
| % reduction | 99.94 | 99.998 | 99.997 | 99.998 | 100.000 | 99.46 |
| by 1.5 ppm | | | | | | |
| buffered | | | | | | |
| aqueous | | | | | | |
| ozone vs. | | | | | | |
| control | | | | | | |

In order to determine the best buffer pH to use in order to provide optimum support to the buffered aqueous ozone assisted killing of S. aureus, a variety of different buffer concentrations were tested. In summary, the optimum pH of the acetate buffer versus S. aureus survival on control coupons is around pH 6. This pH allows for survival of the required number of bacteria on the control coupons when used alone, but is able to increase the efficiency of the aqueous ozone against S. aureus when used in conjunction with 1.5-ppm aqueous ozone. As the pH of the buffer increases towards neutral pH (7), the survival of S. aureus on the control coupons increases until it reaches the required number for test validity under the ASTM method (7.5×10⁵).

Further experiments using the pH 6 acetate buffered aqueous ozone showed an average of at least 99.9% killing of S. aureus in the experimental group treated with 1.5-ppm acetate buffered aqueous ozone versus the control group treated with pH 6 0.05M acetate buffer alone, as shown in Table 3. Notably, the effectiveness of acetate buffer alone was tested compared to water alone. Acetate buffer alone shows limited effectiveness versus S. aureus in the instant methods. Specifically, it shows only a 66.92% reduction versus water, similar to aqueous ozone alone in previous objectives. However, the combination of acetate buffer with 1.5 ppm aqueous ozone in an acetate buffered aqueous ozone solution shows a 99.99% reduction in S. aureus CFU which is statistically significant (p=0.00, Mann Whitney U test).

TABLE 3
Summary results of experiments using treatments containing
0.05M acetate buffer at pH ~6 (n = 3).

| | | Geometric | | |
|---|---|---|---|---|
| Group | Time | Mean | SEM | % reduction |
| Acetate buffer alone | 5 | 1.12E+06 | 129,872.03 | — |
| 1.5 ppm ozone in | 5 | 7.34E+01 | 5,343.14 | 99.99 |
| acetate | | | | |

This effect is seen even using an acetate buffer of higher molarity at the same pH, as seen in Table 4. This decrease in the CFU seen in coupons treated with the acetate buffered aqueous ozone is significant when compared to the control coupons (p=0.000) for both concentrations of acetate buffer. There is a statistically significant difference in CFU on the control coupons with 0.1M acetate buffer (Mann Whitney U test, p=0.005) but the difference in bacterial survival between 0.05M and 0.1M acetate buffered 1.5 ppm ozone is not significant (Mann Whitney U test, p=0.935).

TABLE 4
Summary results of experiments using treatments containing
0.1M acetate buffer at pH ~6 (n = 3).

| | | Geometric | | |
|---|---|---|---|---|
| Group | Time | Mean | SEM | % reduction |
| Acetate buffer alone | 5 | 2.54E+06 | 595,834.37 | — |
| 1.5 ppm ozone in | 5 | 1.21E+02 | 8,636.61 | 100.00 |
| acetate | | | | |

Decreasing the molarity of the buffering solution showed less combined efficacy, as shown in Table 5. When the molarity of the buffer is reduced to 0.01M, a fifth of the original testing concentration, the average percent reduction drops to 99.72%. The standard error for this percent reduction is also large, due to the variable reduction seen in individual experiments (between 51-100%). This reduction was significant (Mann Whitney U test, p=0.000), but it was also significantly lower than the reduction seen with 0.05M acetate (p=0.008) and 0.1M acetate (p=0.011).

TABLE 5
Summary results of experiments using treatments containing
0.01M acetate buffer at pH ~6 (n = 6).

| | | Geometric | | |
|---|---|---|---|---|
| Group | Time | Mean | SEM | % reduction |
| Acetate buffer alone | 5 | 2.31E+06 | 197,454.39 | — |
| 1.5 ppm ozone in | 5 | 6.52E+03 | 112,438.30 | 99.72 |
| acetate | | | | |

Results from a single experiment (shown in Table 6) comparing 1.5 ppm acetate buffered aqueous ozone to water treatment alone showed a similar decrease versus the control, as well as a similar number of live organisms present on the control coupons.

TABLE 6
Summary results of experiments using treatments containing 0.05M
acetate buffer aqueous ozone versus water alone (n = 1).

| | | Geometric | | |
|---|---|---|---|---|
| Group | Time | Mean | SEM | % reduction |
| Water | 5 | 4.82E+06 | 721,880.26 | — |
| 1.5 ppm ozone in | 5 | 1.48E+01 | 37.42 | 100.00 |
| acetate | | | | |

Additionally, not all buffering compounds are suitable or effective for use as additives. In addition to testing acetate buffer, oxalate, citrate, 2-(N-morpholino) ethanesulfonic acid (MES), and ascorbate buffer were also tested while maintaining an approximate pH 5.5 to 6. The MES and ascorbate buffers were unable to accommodate the addition of aqueous ozone, showing no ozone in the resulting solution according to the kiosk sensors and instrumentation.

As seen in Tables 7 and 8, the citrate and oxalate buffers did accept ozonation, and were able to significantly decrease CFU on the treated coupons (Mann Whitney U test, p=0.000), but the percent reduction was much lower than the combination with acetate buffer. This percent reduction with citrate and oxalate buffers also did not show the same ability to cause 99.9% CFU reduction against S. aureus, unlike the acetate buffer.

TABLE 7
Summary results of experiments using treatments containing
0.05M citrate buffer at pH ~5.5 (n = 4).

| | | Geometric | | |
|---|---|---|---|---|
| Group | Time | Mean | SEM | % reduction |
| Citrate buffer alone | 5 | 1.57E+06 | 325,554.79 | — |
| 1.5 ppm ozone in | 5 | 7.59E+05 | 38,416.90 | 51.50 |
| citrate buffer | | | | |

TABLE 8
Summary results of experiments using treatments containing
0.05M oxalate buffer at pH ~5.5 (n = 3).

| | | Geometric | | |
|---|---|---|---|---|
| Group | Time | Mean | SEM | % reduction |
| Oxalate buffer alone | 5 | 2.08E+06 | 259,406.37 | — |
| 1.5 ppm ozone in | 5 | 6.60E+05 | 67,579.23 | 68.27 |
| oxalate | | | | |

Ozone in combination with acetate buffer significantly decreased the number of live S. aureus on glass test coupons following a 5-minute incubation. In contrast to previous studies using aqueous ozone alone, this reduction was also at least 99.9% compared to the control coupons. Aqueous ozone in combination with hydrogen peroxide has some inhibitory affects against certain yeast and fungi (Martin, et al., J. Appl. Microbiol., (2012) 113(6): 1451-60) and aqueous ozone in combination with chlorine can have an additive effect against poliovirus 1 (Harakeh, M. S., FEMS Microbiol. Lett. (1984) 23:21-26). Aqueous ozone also has an increased efficiency in combination with malic acid versus Salmonella enterica on food contact surfaces such as plastic bags and PVC pipe (Singla, et al., J. Biosci. Bioeng. (2014) 118(1): 34-40), or in combination with chlorine versus E. coli in drinking water (De Souza, et al., Environ. Technol. (2011) 32(11-12):1401-8).

In experiments with S. aureus using treatments using 1.5 ppm aqueous ozone in combination with 0.05M acetate buffer, as compared to a water control, acetate buffered 1.5 ppm aqueous ozone had a 4 log reduction of S. aureus CFU post treatment, which was statistically significant (p=0.00). In contrast, a treatment of buffer alone had a less than 1 log reduction. Although this reduction was significant (p=0.00) versus the water control, it was also significantly lower than the acetate buffered 1.5 ppm aqueous ozone combination treatment (p=0.00).

When used to treat test coupons coated with Salmonella enterica, 0.05M acetate buffer alone had a 1 log reduction of CFU versus water. However, acetate buffered 1.5 ppm aqueous ozone showed a 6 log reduction in Salmonella CFU which is statistically significant (p=0.00). Both the combination treatment and the acetate buffer alone also showed effectiveness versus Klebsiella. Acetate buffer alone showed a 1 log reduction in Klebsiella CFU versus the water control. However, the acetate buffered 1.5 ppm aqueous ozone had a 6 log average reduction in Klebsiella CFU following treatment, which is statistically significant (p=0.00). Acetate buffer alone in this experiment also performed significantly better in CFU reduction in comparison to water (p=0.00) but the combination of aqueous ozone and acetate buffer was significantly more effective than buffer alone as well (p=0.00).

Additionally, although acetic acid has been shown to have some germicidal activity alone, the exposure times are generally longer (up to 30 minutes). The data shows that with the addition of aqueous ozone efficient antimicrobial activity can be provided by the combination in only five minutes. Combinations with other buffers such as citric and oxalic acid proved to be far less effective in that time frame. Some buffers such as MES and ascorbic acid, were unable to accept ozone at all. MES buffer is a zwitterionic compound used as a running buffer for Bis-Tris gel electrophoresis, and ascorbic acid, or Vitamin C, is a known antioxidant that is able to attack reactive oxygen species such as hydrogen peroxide in vivo. These properties make it likely that these compounds react with the ozone at time of generation or otherwise interfere with ozone generation by the kiosk, leading to lack of aqueous ozone output.

Citrate and oxalate buffers are able to keep the buffered solution at an acidic pH similarly to the acetate buffer, but did not show the same level of increased efficiency. This likely indicates that pH is not the sole driving force behind the increased efficiency of the combination of aqueous ozone and acetate against S. aureus. Of these buffers, acetate buffer showed the unexpectedly superior ability to accept aqueous ozone as well as a dramatic reduction of S. aureus CFU in five minutes, with an average 99.9% reduction.

The instant results are the first demonstration that acetic acid can be used to increase the efficiency of aqueous ozone against organisms that are resistant to reactive oxygen species, such as Staphylococcus aureus.

### Example 2

Propionic acid (C₃H₆O₂) is a colorless, oily liquid with a pungent, rancid odor and a pKa (logarithmic acid dissociation constant) of 4.88. It occurs naturally in dairy products and is a byproduct of human metabolism. It is used predominantly as a preservative and anti-fungal agent in animal feed and grain. It is also used as a preservative and flavoring agent in packaged foods including baked goods and cheese. Propionic acid, as well as other short chain fatty acids such as acetic, citric, and lactic acid, have shown activity against certain food-borne organisms such as Salmonella, Listeria, and E. coli (Lajhar, et al., BMC Microbiol. (2017) 17(1):47; Menconi, et al., Poult. Sci. (2013) 92(8): 2216-20), as well as activity against fungi (Yun, et al., FEMS Yeast Res. (2016) 16(7): fow089).

Propionate buffers are a buffer that can used to maintain solutions at a pH from approximately 3.8 to 5.8. As shown hereinbelow, the addition of propionate buffer to maintain softened tap water at an acidic pH helps aqueous ozone efficiency against S. aureus.

### Materials and Methods

A freeze-dried stock of Staphylococcus (S. aureus subspecies aureus Rosenbach, strain FDA 209) was obtained from ATCC. After rehydration and growth in appropriate culture medium (Staphylococcus: BD Tryptic soy broth lot #4335611), both plated stocks and stocks frozen in glycerol were created. Staphylococcus was qualified for absorbance at 600 nm versus colony forming units (CFU) by serially diluting inoculum and reading absorbance followed by plating of dilutions onto agar plates. Prior to buffered aqueous ozone testing, growth medium was inoculated and incubated in a shaker incubator (New Brunswick Scientific, serial #890615130) at 37° C. for 24 hours and then transfer cultured two additional times with a final incubation of 48 hours. Twenty microliters of the resulting inoculum was used to coat glass slides (Fisher), also known as test squares or coupons with 10⁵ to 10⁷ cells, as calculated from the standard curve generated from the absorbance qualification data, and allowed to dry in a 37° C. incubator for 40 minutes following ASTM E1153-14 (www.astm.org/Standards/E1153.htm). The experiments tested a single concentration of buffered aqueous ozone (1.5 ppm) with a treatment time of 5 minutes. Briefly, buffered aqueous ozone was generated using the free standing CCT 1.0 unit (mounted in a kiosk enclosure) at a concentration of 1.5 ppm. The water source utilized by the CCT 1.0 unit was clean, cold, softened municipal tap water. Propionate buffer made with a combination of propionic acid and its sodium salt, sodium propionate, was added to the water to provide buffering capability and keep the pH slightly acidic at approximately pH 5.5. Buffered aqueous ozone was collected in a biological safety cabinet before being applied to the appropriate coupons contained within 50 ml conical vials using a pipette. As a control, propionate buffer without aqueous ozone was used. An overview of the parameters is shown in Table 9.

TABLE 9
Experimental conditions.

| | Experiment | | |
|---|---|---|---|
| | 1 | 2 | 3 |
| Water Source | Tap | Tap | Tap |
| CleanCore System | CCT 1.0 | CCT 1.0 | CCT 1.0 |
| Organism | S. aureus | S. aureus | S. aureus |
| Coupon | Glass | Glass | Glass |
| Approx. bacterial load | 1,450,000 | 2,690,000 | 1,560,000 |
| by absorbance | | | |
| PPM | 1.5 | 1.5 | 1.5 |
| Temp. ° C. | Room | Room | Room |
| Incubation time | 5 min | 5 min | 5 min |

After incubation for 5 minutes following ASTM E1153-14, the supernatant in the vial was sampled and placed on test agar plates at a volume of 0.2 ml. An aliquot was also taken for serial dilution at 1:10, 1:100, and/or 1:1000 in tryptic soy broth, which were also placed on test agar plates. All test plates were plated with 0.2 ml spread onto 2 replicates using a glass spreader and an inoculating turntable (Bel-Art, Wayne, N.J.). All plates were then incubated at 37° C. for 48±4 hours. Colony forming units (CFU) for each plate were counted, recorded and averaged for each sample. In order to meet the validity criteria of the method, the control coupons must show at least 7.5×10⁵ surviving organisms. Sample CFUs were analyzed for statistical significance using the Mann Whitney U test with significance level α=0.05.

### Results

A summary of the CFU reductions measured on glass coupon surfaces for the buffered aqueous ozone admixed with propionic acid is presented in Table 10. Experiments using the pH 5.5 propionate buffer showed an average of at least 99.9% killing of S. aureus in the experimental group treated with 1.5-ppm aqueous ozone in pH 5.5 propionate buffer versus the control group treated with pH 5.5 propionate buffer alone, as shown in Table 11. This reduction was statistically significant versus the buffer alone (Mann-Whitney U test, p=0.00). That is, use of buffered aqueous ozone was able to achieve a greater killing efficiency compared to the buffer alone at 5 minutes of exposure. In comparison to the results from treatment with acetate buffered aqueous ozone (see, e.g., Example 1), there was no significant difference in efficacy between acetate and propionate buffered aqueous ozone (Mann Whitney U test, p=0.486). Both acetate and propionate buffering systems are able to increase the ability of aqueous ozone to reduce live bacteria counts.

TABLE 10
Summary of experimental results.

| | Experiment | | |
|---|---|---|---|
| CleanCore System | CCT 1.0 | CCT 1.0 | CCT 1.0 |
| Organism | S. aureus | S. aureus | S. aureus |
| Buffer | propionate | propionate | propionate |
| 1.5 ppm buffered | | | |
| aqueous ozone | | | |
| Average bacterial | 25,000,000 | 49,000,000 | 28,000,000 |
| load (CFU) | | | |
| Geometric mean | 1,337,377 | 1,280,543 | 816,289 |
| control CFU count | | | |
| Geometric mean | 1,620 | 150 | 9 |
| treated CFU count | | | |
| % reduction by 1.5 | 99.88 | 99.99 | 100.00 |
| ppm buffered aqueous | | | |
| ozone vs. control | | | |

TABLE 11
Summary results of experiments using treatments containing 0.05M
propionate buffered aqueous ozone at pH ~6 (n = 3).

| | | Geometric | | |
|---|---|---|---|---|
| Group | Time | Mean | SEM | % reduction |
| Propionate buffer alone | 5 | 1.12E+06 | 100,384.68 | — |
| 1.5 ppm ozone in | 5 | 1.35E+02 | 757.01 | 99.99 |
| propionate buffer | | | | |

The propionate buffered aqueous ozone significantly decreased the number of live S. aureus on glass test coupons following a 5-minute incubation. In contrast to previous studies using aqueous ozone alone, this reduction was also at least 99.9% compared to the control coupons. Aqueous ozone in combination with chlorine can have an additive effect against poliovirus 1 (Harakeh, M. S., FEMS Microbiol. Lett. (1984) 23:21-26). Aqueous ozone also has an increased efficiency in combination with malic acid versus Salmonella enterica on food contact surfaces such as plastic bags and PVC pipe (Singla, et al., J. Biosci. Bioeng. (2014) 118(1):34-40), or in combination with chlorine versus E. coli in drinking water (De Souza, et al., Environ. Technol. (2011) 32(11-12):1401-8). Propionic acid has also shown some promising antifungal activity, possibly by promoting an oxidative environment causing cell death (Yun, et al., FEMS Yeast Res. (2016) 16(7): fow089). With the addition of propionate buffered aqueous ozone, the present studies have shown that the treatment time can be reduced to 5 minutes and still show 99.9% reduction.

The instant results are the first demonstration that propionic acid can be used to increase the efficiency of aqueous ozone against organisms that are resistant to reactive oxygen species, such as Staphylococcus aureus.

### Example 3

Butyric acid (C₄H₈O₂) is a colorless, oily liquid with a strong unpleasant odor similar to rancid butter or cheese. The logarithmic acid dissociation constant (pKa) of butyric acid is 4.82. It occurs naturally in dairy products and is a natural byproduct of fermentation. Butyric acid and other short chain fatty acids have been shown to have activity against some types of cancer in humans (Rodriguez-Alcala, et al., Biosci. Rep. (2017) 37(6):BSR20170705; Molina, et al., Chem. Phys. Lipids (2013) 175-176: 50-6; Astakhova, et al., PLoS One (2016) 11(7): e0154102). Butyric acid and other additives have also been shown to have antibacterial activity against Escherichia coli O157:H7 when used to treat drinking water (Zhao, et al., Appl. Environ. Micriobiol. (2006) 72(5):3268-73).

Here, the effect of using butyric acid as a water buffering additive was tested on the efficiency of aqueous ozone against organisms that are resistant to reactive oxygen species, such as Staphylococcus aureus. Butyrate buffers are buffers that can be used to maintain solutions at a pH from approximately 3.8 to 5.8. As seen below, the addition of a butyrate buffer to maintain softened tap water at an acidic pH helps aqueous ozone efficiency against S. aureus.

### Materials and Methods

A freeze-dried stock of Staphylococcus (S. aureus subspecies aureus Rosenbach, strain FDA 209) was obtained from ATCC. After rehydration and growth in appropriate culture medium (Staphylococcus: BD Tryptic soy broth lot #4335611), both plated stocks and stocks frozen in glycerol were created. Staphylococcus was qualified for absorbance at 600 nm versus colony forming units (CFU) by serially diluting inoculum and reading absorbance followed by plating of dilutions onto agar plates. Prior to aqueous ozone testing, growth medium was inoculated and incubated in a shaker incubator (New Brunswick Scientific, serial #890615130) at 37° C. for 24 hours and then transfer cultured two additional times with a final incubation of 48 hours. Twenty microliters of the resulting inoculum was used to coat glass slides (Fisher), also known as test squares or coupons, with 10⁵ to 10⁷ cells, as calculated from the standard curve generated from the absorbance qualification data, and allowed to dry in a 37° C. incubator for 40 minutes following ASTM E1153-14 (www.astm.org/Standards/E1153.htm). The experiments tested a single concentration of buffered aqueous ozone (1.5 ppm) with a treatment time of 5 minutes. Briefly, buffered aqueous ozone was generated using the free standing CCT 1.0 unit (mounted in a kiosk enclosure) at a concentration of 1.5 ppm. The water source utilized by the CCT 1.0 unit was clean, cold, softened municipal tap water. Butyrate buffer made with a combination of butyric acid and its sodium salt, sodium butyrate, was added to the water to provide buffering capability and keep the pH slightly acidic at approximately pH 5.5. Buffered aqueous ozone was collected in a biological safety cabinet before being applied to the appropriate coupons contained within 50 ml conical vials using a pipette. As a control, butyrate buffer without aqueous ozone was used. An overview of the parameters is shown in Table 12.

TABLE 12
Experimental conditions.

| | Experiment | | |
|---|---|---|---|
| | 1 | 2 | 3 |
| Water Source | Tap | Tap | Tap |
| CleanCore System | CCT 1.0 | CCT 1.0 | CCT 1.0 |
| Organism | S. aureus | S. aureus | S. aureus |
| Coupon | Glass | Glass | Glass |
| Approx. bacterial load | 1,644,000 | 1,962,000 | 3,243,000 |
| by absorbance | | | |
| PPM | 1.5 | 1.5 | 1.5 |
| Temp. ° C. | Room | Room | Room |
| Incubation time | 5 min | 5 min | 5 min |

Following incubation for 5 minutes following ASTM E1153-14, the supernatant in the vial was sampled and placed on test agar plates at a volume of 0.2 ml. An aliquot was also taken for serial dilution at 1:10, 1:100, and/or 1:1000 in tryptic soy broth, which were also placed on test agar plates. All test plates were plated with 0.2 ml spread onto 2 replicates using a glass spreader and an inoculating turntable (Bel-Art, Wayne, N.J.). All plates were then incubated at 37° C. for 48±4 hours. Colony forming units (CFU) for each plate were counted, recorded and averaged for each sample. In order to meet the validity criteria of the method, the control coupons must show at least 7.5×10⁵ surviving organisms. Sample CFUs were analyzed for statistical significance using the Mann Whitney U test with significance level α=0.05.

### Results

A summary of the CFU reductions measured on the glass coupon surfaces for the aqueous ozone is presented in Table 13. Experiments using the pH 5.5 butyrate buffered aqueous ozone showed an average of at least 99.9% killing of S. aureus in the experimental group treated with 1.5-ppm butyrate buffered aqueous ozone versus the control group treated with butyrate buffer alone, as shown in Table 14. This decrease in the CFU seen in coupons treated with the buffer-aqueous ozone combination is significant when compared to the control coupons (Mann Whitney U test, p=0.000). However, in comparison to acetate and propionic buffered aqueous ozone, the performance of butyrate buffered ozone was less effective at 99.92% versus 99.99% for acetate buffered ozone (Mann Whitney U test, p=0.021) and propionate buffered ozone (Mann Whitney U test, p=0.045).

TABLE 13
Summary of experimental results.

| | Experiment | | |
|---|---|---|---|
| CleanCore System | CCT 1.0 | CCT 1.0 | CCT 1.0 |
| Organism | S. aureus | S. aureus | S. aureus |
| Buffer | butyrate | butyrate | butyrate |
| 1.5 ppm buffered | | | |
| aqueous ozone | | | |
| Average bacterial | 33,500,000 | 41,500,000 | 63,000,000 |
| load (CFU) | | | |
| Geometric mean | 795,984 | 1,042,113 | 1,628,666 |
| control CFU count | | | |
| Geometric mean | 22 | 9,703 | 3,056 |
| treated CFU count | | | |
| % reduction by 1.5 | 100.00 | 99.07 | 99.81 |
| ppm buffered aqueous | | | |
| ozone vs. control | | | |

TABLE 14
Summary results of experiments using treatments containing
0.05M butyrate buffer at pH ~5.5 (n = 3).

| | | Geometric | | |
|---|---|---|---|---|
| Group | Time | Mean | SEM | % reduction |
| Butyrate buffer alone | 5 | 1.11E+06 | 144,332.76 | — |
| 1.5 ppm ozone in | 5 | 8.75E+02 | 5,399.80 | 99.92 |
| butyrate buffer | | | | |

Butyrate buffered aqueous ozone significantly decreased the number of live S. aureus on glass test coupons following a 5-minute incubation in comparison to the control (aqueous butyrate buffer solution) group. In contrast to previous studies using aqueous ozone alone, this reduction was also at least 99.9% lower on average compared to the control coupons. Aqueous ozone in combination with chlorine has an additive effect on disinfection against poliovirus 1 (Harakeh, M. S., FEMS Microbiology Letters (1984) 23:21-26). Aqueous ozone also has an increased efficiency in combination with malic acid versus Salmonella enterica on food contact surfaces such as plastic bags and PVC pipe (Singla, et al., J. Biosci. Bioeng. (2014) 118(1):34-40), or in combination with chlorine versus E. coli in drinking water (De Souza, et al., Environ. Technol. (2011) 32(11-12):1401-8). However, the instant results are the first demonstration that butyric acid can be used to increase the efficiency of aqueous ozone against organisms that are resistant to reactive oxygen species, such as Staphylococcus aureus.

### Example 4

Currently, there are a number of peracetic acid (PAA) products on the market that are Environmental Protection Agency (EPA) registered disinfectant products. The Center for Disease Control (CDC) has issued the Guidelines for Disinfection and Sterilization in HealthCare Facilities (2008) which outlines the uses and concentrations of PAA. One of these PAA disinfectant products is Spor-Klenz® (STERIS Corp.; Mentor, Ohio), with a ready to use concentration of 800 ppm. Herein, the ability of PAA to reduce bacterial CFU when combined with aqueous ozone was tested.

### Materials and Methods

A freeze-dried stock of Staphylococcus (Staphylococcus aureus subspecies aureus Rosenbach, strain FDA 209), as specified by the AOAC method (961.02), was obtained from ATCC. After rehydration and growth in appropriate culture medium (BD Tryptic soy broth lot #4335611), both plated stocks and stocks frozen in glycerol were created. Staphylococcus was quantified for absorbance at 600 nm versus colony forming units (CFU) by serially diluting inoculum and reading absorbance followed by plating of dilutions onto agar plates. Prior to aqueous ozone testing, growth medium was inoculated and incubated in a shaker incubator (New Brunswick Scientific, serial #890615130) at 37° C. for 24 hours and then transfer cultured two additional times with a final incubation of 48 hours. Twenty microliters of the resulting inoculum was used to coat glass slides (Fisher), also known as test squares or coupons, with 10⁵ to 10⁷ cells, as calculated from the standard curve generated from the absorbance qualification data, and allowed to dry in a 37° C. incubator for 40 minutes following ASTM E1153-14. After drying, treated coupons were sequentially treated with 1.5 or 4 ppm aqueous ozone alone, 1.5 or 4 ppm aqueous ozone combined with a predetermined dilution of PAA, or PAA alone, then incubated for 10 minutes at room temperature. Additionally, immediately before and after testing three inoculated untreated coupons were place in labeled 50 ml conical tubes containing 20 ml of Letheen broth, vortexed, pooled, and plated to provide carrier counts. The mean log 10 density (LD) of the carrier counts for S. aureus must be between 5.0 and 6.5 in order for the test to be valid in this method.

Briefly, aqueous ozone was generated using the free standing CCT 1.0 unit (mounted in a kiosk enclosure) at a concentration of 1.5 ppm or 4 ppm. The water source utilized by the CCT 1.0 was clean, cold, softened Omaha municipal tap water. As Omaha municipal tap water pH is typically between 8.5 and 9 a further water treatment step was implemented to reduce the pH to between 6 and 8. Aqueous ozone was sterile collected in a biological safety cabinet before and used immediately. Treatments were applied to the appropriate freshly prepared coupons contained within labeled petri dishes using a sprayer provided by CleanCore. An overview of the parameters is shown in Table 15.

TABLE 15
Experimental conditions.

| | Experiment | | |
|---|---|---|---|
| | 1 | 2 | 3 |
| Water Source | Tap | Tap | Tap |
| CleanCore System | CCT 1.0 | CCT 1.0 | CCT 1.0 |
| Organism | S. aureus | S. aureus | S. aureus |
| Coupon | Glass | Glass | Glass |
| Approx. bacterial | 78,800,000 | 62,700,000 | 88,100,000 |
| load by absorbance | | | |
| PPM | 1.5 | 4 | 1.5 |
| PPM PAA | 15 | 15 | 10 |
| Temp. ° C. | Room | Room | Room |
| Incubation time | 10 min | 10 min | 10 min |
| | 4 | 5 | 6 |
| Water Source | Tap | Tap | Tap |
| CleanCore System | CCT 1.0 | CCT 1.0 | CCT 1.0 |
| Organism | S. aureus | S. aureus | S. aureus |
| Coupon | Glass | Glass | Glass |
| Approx. bacterial | 75,700,000 | 81,600,000 | 81,900,000 |
| load by absorbance | | | |
| PPM | 1.5 | 1.5 | 1.5 |
| PPM PAA | 20 | 20 | 20 |
| Temp. ° C. | Room | Room | Room |
| Incubation time | 10 min | 10 min | 10 min |

Following the testing period, coupons were removed from the individual petri dishes and transferred to corresponding labeled 50 ml conical tubes containing 20 ml of Letheen broth. One sterile un-inoculated coupon and one inoculated untreated coupon were also transferred to separate labeled 50 ml conical tubes containing 20 ml of Letheen broth in order to provide sterility and viability controls, respectively. All testing vials were shaken then incubated at 36±1° C. for 48±2 hours, then visually assessed for turbidity(+). Positive sample vials were plated to determine colony morphology similarity to test organism. All test plates were plated with 0.2 ml spread onto 2 replicates using a glass spreader and a Bel-Art inoculating turntable. Results of testing were analyzed for statistical significance in SPSS using a McNemar exact test for dichotomous data, with a significance level of α=0.05.

### Results

Prior to specific testing, various concentrations of PAA (5 ppm to 200 ppm) were diluted in sterile water and used to treat coupons, as described above in the methods, in order to determine a range of concentrations to be used for comparison testing. As the concentration of PAA increases, the number of negative coupons also increases. For example, 3 out of 10 coupons were negative at 10 ppm; 6 out of 10 were negative at 25 ppm; and 9 out of 10 coupons negative at 50 ppm and 100 ppm. Notably, 100 ppm is ⅛ of the ready-to-use concentration. Since some, but not complete activity, was needed in the control groups, initial comparison testing focused on using concentrations of PAA between 10 and 25 ppm. In other words, a concentration of PAA that showed incomplete activity was used. These concentrations are also close to the sanitizer concentration of Spor-Klenz®, which is a 1:50 dilution or about 16 ppm.

As seen in Table 16A, the addition of aqueous ozone improved the efficacy of the diluted PAA when used at a concentration of 1.5 ppm. The combination of aqueous ozone with a low concentration of PAA (15 ppm) showed a 13.3% increase in efficiency over the same concentration of PAA alone. Testing was also performed with 4 ppm aqueous ozone combined with 15 ppm PAA, which also showed increased reduction in the combined group in comparison to the PAA alone group (Table 16B). To determine if the combination group would continue to show greater efficiency even with lower concentrations of PAA, the next set of experiments used 10 ppm PAA with or without 1.5 ppm aqueous ozone. As seen in Table 16C, there is little disinfection seen with 10 ppm PAA alone, but in the PAA/aqueous ozone combination group, the efficacy is almost eight times greater than PAA alone.

Lastly, coupons were treated with a slightly increased concentration of PAA, in order to determine the minimum amount of PAA in combination with aqueous ozone that would provide the disinfection desired by the method—which is 59 out of 60 coupons negative, or, in the modified method, 29 out of 30 coupons negative. As shown in Table 16D, increasing the concentration of PAA to 20 ppm allows a 10% increase in the combination group over the PAA alone group, and reached the threshold of only 1 positive coupon out of 29 treated coupons in three total experiments.

TABLE 16A
Efficacy of PAA in combination with 1.5 ppm aqueous ozone.

| Group | Number+ | Number− | Percent kill |
|---|---|---|---|
| 1.5 ppm ozone alone | 30 | 0 | 0.0% |
| 1.5 ppm ozone with 15 | 3 | 27 | 90.0% |
| ppm PAA | | | |
| 15 ppm PAA alone | 7 | 23 | 76.7% |

TABLE 16B
Efficacy of PAA in combination with 4 ppm aqueous ozone.

| Group | Number+ | Number− | Percent kill |
|---|---|---|---|
| 4 ppm ozone alone | 30 | 0 | 0.0% |
| 4 ppm ozone with 15 ppm | 6 | 24 | 80.0% |
| PAA | | | |
| 15 ppm PAA alone | 8 | 22 | 73.3% |

TABLE 16C
Efficacy of PAA in combination with 1.5 ppm aqueous ozone.

| Group | Number+ | Number− | Percent kill |
|---|---|---|---|
| 1.5 ppm ozone alone | 30 | 0 | 0.0% |
| 1.5 ppm ozone with 10 | 14 | 16 | 53.3% |
| ppm PAA | | | |
| 10 ppm PAA alone | 28 | 2 | 6.7% |

TABLE 16D
Efficacy of PAA in combination with 1.5 ppm aqueous ozone.

| Group | Number+ | Number− | Percent kill |
|---|---|---|---|
| 1.5 ppm ozone alone | 90 | 0 | 0.0% |
| 1.5 ppm ozone with 20 | 2 | 88 | 97.8% |
| ppm PAA | | | |
| 20 ppm PAA alone | 11 | 79 | 87.8% |

Thus, at all concentrations tested, the group treated with a combination of aqueous ozone and diluted PAA has shown greater activity versus the groups treated with aqueous ozone or diluted PAA alone.

### Example 5

Peracetic acid (PAA) is often used in food processing facilities, particularly poultry processing facilities, as an antimicrobial against pathogens such as Salmonella, E. coli, and Campylobacter. However, PAA is known to be corrosive and an irritant, particularly to the eyes, skin, respiratory tract, and mucous membranes. Indeed, as little as 5 ppm of PAA can cause irritation to the upper respiratory tract in humans after exposure (Acute Exposure Guideline Levels for Selected Airborne Chemicals: Volume 8; National Research Council (US) Committee on Acute Exposure Guideline Levels. Washington (D.C.): National Academies Press (US); 2010). Herein, to supplement the results presented above in Example 4, the effectiveness of PAA in combination with ozone as antimicrobial spray on food products, particularly chicken, was tested—as well as the ability of ozone to mitigate ambient PAA.

Briefly, chicken carcasses (70 whole hen carcasses for 7 treatments and 10 replications) were inoculated with 400 mL of a cocktail containing Salmonella Typhimurium (UK-1), E. coli (J53), and Campylobacter jejuni (3×10⁷ CFU/mL) and allowed to adhere for 60 minutes at 4° C. for a final concentration of 10⁵-10⁶ CFU/g. Chicken carcasses then received no treatment (negative control) or were then treated by spraying (4×5 seconds) with tap water, tap water with 10 ppm ozone, tap water with PAA (50 ppm), tap water with PAA (500 ppm), tap water with 10 ppm ozone and PAA (500 ppm), or tap water with 10 ppm ozone and PAA (50 ppm). Further, the ambient PAA was measured using a PAA specific sensor during treatment. After treatment, chicken carcasses were rinsed in 400 mL of neutralizing buffered peptone water (20.0 g of buffered peptone, 7 g of refined soy lecithin or equivalent, 1.0 g of sodium thiosulfate, 12.5 g of sodium bicarbonate, per 1 liter of deionized water) for 2 minutes with agitation. Subsequently, the rinsate was serially diluted, spread plated on Xylose Lysine Deoxycholate (XLD) and Blood Free Campylobacter Agar (BFCA; modified Charcoal-Cefoperazone-Deoxycholate agar (mCCDA)), and incubated aerobically at 37° C. for 24 hours and microaerophilic at 42° C. for 48 hours, respectively. Log-transformed counts were analyzed using one-way ANOVA in JMP 14.0. Means were separated using Tukey's HSD when P≤0.05.

There was a significant treatment effect among Salmonella, E. coli, and Campylobacter counts as well as with ambient PAA (P≤0.05). Tap water with 10 ppm ozone and PAA (500 ppm) significantly reduced Salmonella and E. coli compared to tap water. For example, carcasses treated with TW+500 ppm PAA+O₃ (5.71 log CFU/g of Salmonella) had significantly lower log CFU per gram of Salmonella than those treated with TW alone (6.30 log CFU/g of Salmonella) and lower than those treated with TW+500 ppm PAA (5.86 log CFU/g of Salmonella). Additionally, carcasses treated with TW+500 ppm of PAA+O₃ (˜5.7 log CFU/g of E. coli) yielded a lower load of E. coli than those not treated (6.18 log CFU/g of E. coli). Further, tap water with PAA (50 ppm), tap water with PAA (500 ppm), and tap water with 10 ppm ozone and PAA (500 ppm) significantly reduced Campylobacter compared to untreated controls. For example, carcasses treated with TW+500 ppm PAA+O₃ (4.86 log CFU/g of C. jejuni) had significantly lower log CFU per gram of C. jejuni than untreated controls (5.20 log CFU/g of C. jejuni) and similar to those treated with TW+500 ppm PAA (4.81 log CFU/g of C. jejuni).

Moreover, the addition of ozone significantly reduced the ambient PAA. Indeed, tap water with 10 ppm ozone and PAA (500 ppm) (0.008 ppm ambient) produced significantly less ambient PAA than tap water with PAA (500 ppm) (0.565 ppm ambient). Thus, the addition of ozone to PAA increases the efficacy of PAA while diminishing ambient PAA, thereby increasing consumer and employee safety.

A number of publications and patent documents are cited throughout the foregoing specification in order to describe the state of the art to which this invention pertains. The entire disclosure of each of these citations is incorporated by reference herein.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

1. An aqueous ozone composition comprising water, ozone, and a buffering agent, wherein the buffering agent has the formula R—COOH, wherein R is an alkyl or lower alkyl, or a salt thereof.

2. The aqueous ozone composition of claim 1, wherein the buffering agent is selected from the group consisting of propionic acid, butyric acid, acetic acid, and salts thereof.

3. The aqueous ozone composition of claim 1, wherein said salt is a sodium salt.

4. The aqueous ozone composition of claim 1, wherein the pH of the aqueous ozone composition is about 5.5 to about 6.0.

5. The aqueous ozone composition of claim 1, wherein the concentration of said buffering agent is about 0.01 M to about 1.0 M.

6. The aqueous ozone composition of claim 1, wherein the concentration of said ozone is about 0.5 ppm to about 5.0 ppm.

7. The aqueous ozone composition of claim 1 consisting of water, ozone, and said buffering agent.

8. The aqueous ozone composition of claim 1, wherein the buffering agent is selected from the group consisting of propionic acid, butyric acid, acetic acid, and salts thereof, and wherein the pH of the aqueous ozone composition is about 5.5 to about 6.0.

9. The aqueous ozone composition of claim 8, wherein the concentration of said ozone is about 0.5 ppm to about 5.0 ppm.

10. The aqueous ozone composition of claim 8, wherein the buffering agent is acetic acid or a salt thereof.

11. An aqueous ozone composition comprising water, ozone, and peracetic acid.

12. The aqueous ozone composition of claim 11, wherein the concentration of said ozone is about 0.5 ppm to about 5.0 ppm.

13. The aqueous ozone composition of claim 11, wherein the concentration of said peracetic acid is about 10 ppm to about 1000 ppm.

14. The aqueous ozone composition of claim 11, wherein the concentration of said ozone is about 0.5 ppm to about 5.0 ppm and the concentration of said peracetic acid about is 10 ppm to about 1000 ppm.

15. The aqueous ozone composition of claim 11 consisting of water, ozone, and peracetic acid.

16. A method for disinfecting, sanitizing, cleaning, and/or sterilizing a surface, said method comprising applying to said surface the aqueous ozone composition of claim 1.

17. The method of claim 16, wherein said method reduces the number of living microorganisms on said surface by at least 99.9%.

18. (canceled)

19. The method of claim 17, wherein said microorganisms are bacteria.

20. The method of claim 19, wherein said bacteria are a Staphylococcus.

21. (canceled)

22. The method of claim 16, wherein said surface is in a food processing environment or is a food product or component.

23. (canceled)

24. The method of claim 23, wherein said applying step comprises a food rinse, spray, or submersion.

25. The method of claim 16, wherein said method reduces the number of living microorganisms on said surface by at least one logarithm.

26. A method for disinfecting, sanitizing, cleaning, and/or sterilizing a surface, said method comprising applying to said surface the aqueous ozone composition of claim 11.
